(19) United States
(12) Patent Application Publication
(10) Pub. No.: US 2015/0090345 A1
(43) Pub. Date: Apr. 2, 2015

(54) ROTARY SELECTION VALVE

(71) Applicant: GE HEALTHCARE BIO-SCIENCES AB, UPPSALA (SE)

(72) Inventor: Bjorn Olovsson, Uppsala (SE)

(73) Assignee: GE HEALTHCARE BIOSCIENCES AB, UPPSALA (SE)

(21) Appl. No.: 14/396,610

(22) PCT Filed: Apr. 26, 2013
(86) PCT No.: PCT/EP2013/058752

§ 371 Date: Oct. 23, 2014

(30) Foreign Application Priority Data
Apr. 27, 2012 (GB) 1207365.6

(51) Int. Cl. F16K 11/07; B08B 9/032

(52) U.S. Cl. CPC F16K 11/0716; B08B 9/032
USPC 137/15.06; 251/310; 137/625.24

(57) ABSTRACT

A rotary selection valve (1) is disclosed having a stator (20) and a rotor (40) having complementary abutting fluid tight surfaces (30,50) for relative rotation between the stator (20) and the rotor (40) about a rotational axis. The stator or rotor has at least one connection port in fluid communication with an associated orifice at said stator or rotor abutment surfaces (30,50). The stator and/or rotor further comprise a separate fluid recess extending radially beyond said associated orifice or orifices and open to the complementary abutment surfaces for improving the automatic cleaning of the valve.

### FIELD OF THE INVENTION

The present invention relates to rotary valves for controlling fluid flow, particularly, but not exclusively, fluid flow in laboratory or bio-processing equipment such as chromatographic equipment, and more specifically to valves for directing fluid flow along a desired path, selected from a set of such paths.

### BACKGROUND OF THE INVENTION

Rotary valves are commonly used in devices for controlling fluid flow. A typical type of valve, for example used in laboratory equipment of moderate sizes such as a liquid chromatography system (LCS), is a rotary selection valve employed to select an appropriate fluid path from a number of paths and thus to redirect fluid from one fluid path to another fluid path.

Generally, a rotary valve has a stationary body, herein called a stator, which co-operates with a rotating body, herein called a rotor.

In commercially available LCS rotary valves, the stator is provided with a number of inlet and outlet ports. The ports are in fluid communication with a corresponding set of orifices on an inner stator face, via bores in the stator. The inner stator face is an inner surface of the stator that is in generally fluid tight abutment with an inner rotor face of the rotor. The rotor is typically formed as a disc and the inner rotor face is pressed against the inner stator face in rotating co-operation. The inner rotor face is provided with one or more grooves which interconnect different stator orifices depending on the rotary position of the rotor with respect to the stator.

Rotary valves can be designed to withstand high pressures (such as pressures above 30 MPa). They can be made from a range of materials, such as stainless steel, high performance polymeric materials and ceramics.

The number of inlets/outlets as well as the design of grooves in the rotator or the stator reflects the intended use of a specific rotary valve.

A common type of multi-purpose valve has one inlet port (typically placed in the rotary axis of the valve) and a number of outlet ports that are placed around the inlet port. The rotor has a single, radially extending groove that has one end in the rotary axis, thereby always in fluid communication with the inlet, while the other end can be in fluid communication with any one of the outlets depending on the angular position of the rotor with respect to the stator. Such a valve is useful to direct a flow from the inlet to any of the outlets—one at a time. Other arrangements of fluid paths are known also.

Whilst these valves function very well, small amounts of leakage are possible between the abutting rotor and stator faces, which manifests itself as growths of bacteria and other microorganisms, usually around the orifices on the stator where the leakage has taken place. This in turn leads to contamination in the fluid paths as the rotor moves between selected angular positions. For highly sensitive laboratory equipment, this contamination is not acceptable, and so the valve has to be dismantled and cleaned regularly, which takes time and renders the equipment inoperable during cleaning

### SUMMARY OF THE INVENTION

Embodiments of the invention provide an improved rotary selection valve that required less cleaning and is thus more convenient to use.

According to one aspect the invention consists in a rotary selection valve, the valve comprising a stator and a rotor, said stator and rotor each having complementary abutment surfaces for allowing generally fluid tight relative rotation between the stator and the rotor about a rotational axis, said stator or rotor comprising at least one connection port in fluid communication with an associated orifice at said stator or rotor abutment surface, the invention being characterised in that said stator and/or said rotor further comprises a fluid recess extending radially beyond said associated orifice or orifices and open to the complementary abutment surfaces.

In an embodiment, said at least one connection port is a plurality of connection ports and the valve includes a plurality of associated orifices at the complementary abutment surfaces, and wherein the fluid recess substantially circumscribes the orifices.

Optionally, the orifices are arranged in a circular array and said recess is formed at least radially outwardly of each orifice in the array.

Optionally, the recess extends also between the orifices in the array.

In an embodiment, the recess has an inlet and in outlet, each in fluid communication with a respective connection port at the stator or rotor.

Optionally the inlet is located generally at the rotational axis, and the fluid recess further extends to the inlet at the rotational axis.

According to a second aspect the invention consists in a rotary selection valve, the valve comprising a stator and a rotor, said stator and rotor each having complementary abutment surfaces for allowing generally fluid tight relative rotation between the stator and the rotor about a rotational axis, said stator comprising a plurality of connection ports each in fluid communication with an associated orifice in said stator abutment surface, characterised in that said stator further comprises a fluid recess extending radially beyond said orifices and open to the stator abutment surface, in that the fluid recess extends also in between the orifices, in that an inlet for the fluid channel is formed by a further central orifice at the rotational axis and in that a fluid path is formed in the rotor extending from the inlet radially outwardly to meet the fluid recess.

According to another aspect, the invention consists in a method of cleansing a rotary selection valve, the method comprising the step of causing fluid to flow in a fluid recess of a rotary selection valve, the valve comprising a stator and a rotor, said stator and rotor each having complementary abutment surfaces for allowing generally fluid tight relative rotation between the stator and the rotor about a rotational axis, said stator or rotor comprising at least one connection port in fluid communication with an associated orifice at said stator or rotor abutment surface, and the fluid recess comprising a fluid recess extending radially beyond said associated orifice or orifices and open to the complementary abutment surfaces. Said flow may be constant or periodic. Said flow may be caused by a pump associated with flow of further fluids in the or each connection port and associated orifice.

The invention is further defined in the claims, but the invention is not so limited, and any novel combination of features described herein is intended to fall within the ambit of this invention.

### BRIEF DESCRIPTION OF THE DRAWINGS

The invention can be put into effect in numerous ways, illustrative embodiments of which are described below with reference to the drawings, wherein:

FIG. 1 shows a sectional view of part of a rotary valve;

FIG. 2 shows an end view of the stator of the valve shown in FIG. 1 viewed in the direction of arrow A in FIG. 1;

FIG. 3 shows an end view of the rotor of the valve shown in FIG. 1 viewed in the direction of arrow B in FIG. 1;

FIGS. 4 and 5 show respectively alternative arrangements of the stator and the rotor; and

FIGS. 6, 7 and 8 each show alternative arrangements of the stator.

### DETAILED DESCRIPTION OF THE INVENTION

Referring to FIG. 1, a rotary valve 1 is illustrated showing the main parts. The valve 1 includes a housing 10, a stator 20, a rotor 40 and a drive dog 60, for connection to a stepper motor or other rotary drive (not shown). The drive will in practice include a means (not shown) for recognizing the angular position of the rotor. Manual operation of the valve is possible also. The rotor 40 is rotatable with respect to the stator 20 about a rotary axis RA of the valve, as a result of the rotary motion of the drive dog 60.

The stator 20, is fixed with respect to the housing 10 and is provided with ports. Ports 22, 26 and 28 are visible in FIG. 1 but more than three ports will generally be provided. The ports allow selective fluid communication between a source and any components with which the valve is to co-operate. The ports may be situated on any suitable position on the exterior surface of the stator. The ports are provided with means to connect capillaries or tubing, in this case, threaded recesses 23,25 and 29. Other connections are known in the art. Via fluid communication channels, the ports 22,26 and 28 are in fluid communication with a corresponding set of orifices 21,24 and 27 on the end face 30 of the stator 20, i.e. the surface of the stator 20 that during operation abuts with the rotor 40.

The rotor 40 is typically formed as a disc and has a rotor end face 50, i.e. the surface pressed against the inner stator face 30 during operation. The faces 30 and 50 are complementary such that they provide generally fluid tight abutment. Most conveniently these faces are flat, but other complementary shapes are possible, for example they may be matched part-spherical or conical shapes. The inner rotor face 30 too is provided with a fluid communication channel, in the form of a groove 32 in the end face 30.

In use the rotor 40 can be rotated about axis RA such that the orifice 21 which remains always in communication with the groove 32, is selectively caused to communicate with either orifice 24 or orifice 27, or, in practice other circumferentially arranged orifices not shown. Thus various stator outlet ports can be made to communicate selectively with the central inlet port 22. In FIG. 1, fluid flow is in the direction of arrows FF in use.

The foregoing detailed description is generally conventional. However, the valve shown in FIG. 1 includes a novel feature of a generally annular recess 34 which extends generally around the orifices 21, 24 and 27 in the abutment face 30 of the stator 20. This recess provides a space for leaking fluid to collect and is described in more detail below. The groove is generally separate to the orifices 21,24, and 27 shown, i.e. there is no substantial fluid communication between the groove 32 and the cooperating orifices in the stator 20.

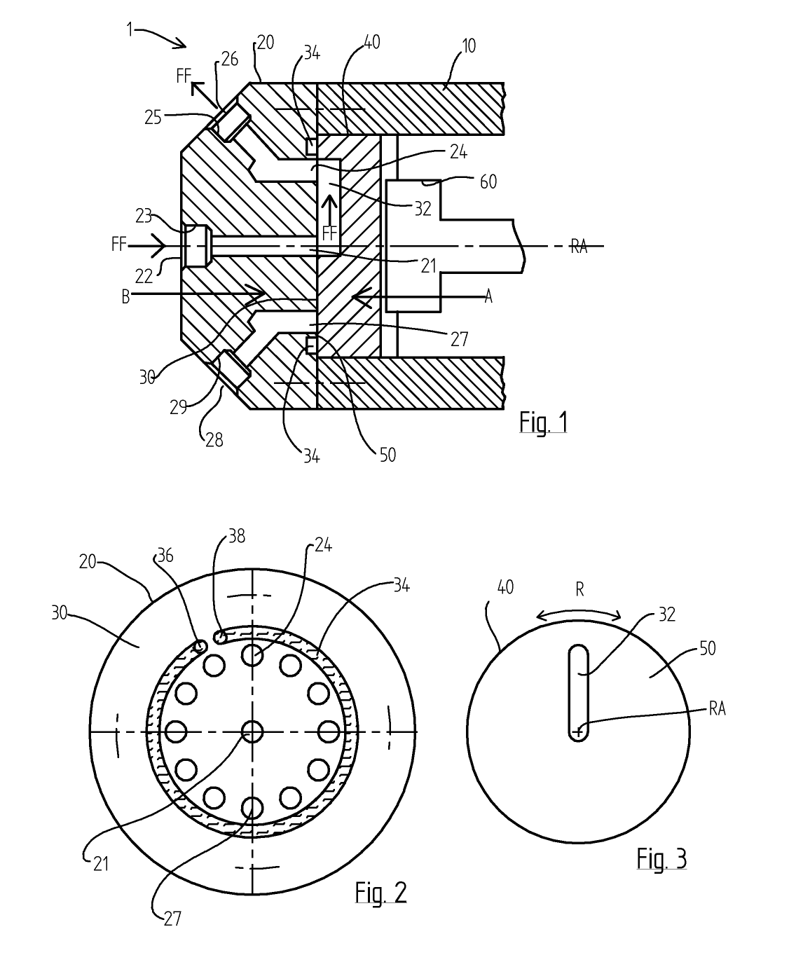

FIGS. 2 and 3 show respectively the end face 30 of the stator 20, as viewed in the direction of arrow A in FIG. 1; and the end face 50 of rotor 40, as viewed in the direction of arrow B. Further orifices in addition to those shown in FIG. 1 form a circular array, and are in selective fluid communication with the central orifice 21 via groove 32, in the manner described above. The recess 34 is visible, formed as an annulus and having an inlet 36 and an outlet 38 each in fluid communication with a connection port (not shown) of the stator 20.

In use the recess 34 will contain a flushing or cleansing fluid which is constantly or periodically changed, to keep the valve clean. The cleansing fluid can have a reduced pressure compared to the working pressure at the orifices, 21, 24 or 27 so any leakage is more likely to flow toward the recess 34, away from the orifices.

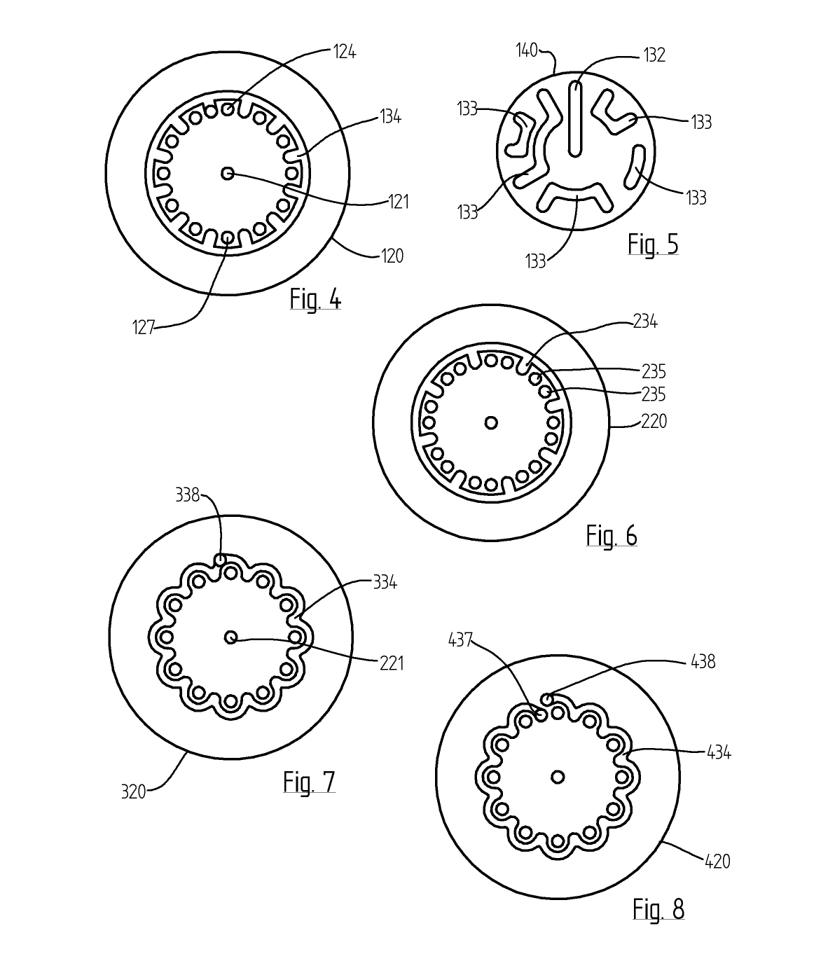

FIGS. 4 and 5 shown alternative stator (120) and rotor (140) arrangements. The end faces of the stator and rotor are again shown, but it will be noted that a cleansing recess 134 extends not only radially outwardly of the generally circular array of twelve orifices (only two of which are referenced as 124 and 127), but also between these orifices also. The recess 134 has an outlet 138, and an inlet 121, which inlet is shared with the supply inlet for the twelve orifices. A groove 132 in the rotor 140 supplies both the orifices and the recess, and can be stopped during rotation at the appropriate position. As the groove 132 rotates, it will be cleaned between contact with each neighbouring orifice. Additional further optional grooves 133 formed in the end face 150 of the rotor 140 can be used to interconnect different orifices and thereby to enhance the functionality of the valve.

FIGS. 6, 7 and 8 show variations of respective stators 220, 320, and 420. In each case they are intended to cooperate with the rotor 40 or 140 as the same as shown in FIG. 3 or 5, or a similar rotor.

The stator 220 shown in FIG. 6 has a cleansing recess 234 which encroaches radially into the pitch circle of the orifices described above only between adjacent pairs of orifices 235 only one pair being references. This reduces the number of times which the corresponding groove 32 or 132 is cleansed during operation. This is beneficial where cleaning need not be done between every adjacent stator orifice.

The recess 334 shown in FIG. 7 has a generally constant width, which promotes linear flow characteristics, in turn providing fewer ‘dead’ spaces where the cleansing fluid stagnates. This improves the cleansing action of fluid flowing in the recess 234. The recess 334 has an outlet 338 and relies on the central orifice 221 for inflow of fluid.

The recess 434 shown in FIG. 8 is a similar shape to the recess 334 described above and has the same advantages. In this variant, the recess 434 has an inlet 437 and an outlet 438 to maintain flow in the recess. In this case fluid in the corresponding channel 32 or 132 in the rotor, remains while the rotor rotates, but the radially outer end of the channel is effectively wiped clean as it moves over the portions of the recess which encroach into the travel circumscribed by the channel 32 or 132.

The rotor and stator parts mentioned above are intended to be manufactured from machined or moulded plastics, such as Polyetheretherketone (PEEK), with or without fibre reinforcement, and preferably filled with carbon to reduce friction at their abutting sliding surfaces.

Whilst one embodiment and variants have been described and illustrated, it will be apparent to the skilled addressee that other additions, modifications or omissions are possible, within the scope of the claims. For example, the recesses 34, 134, 234, 334 and 434 each generally circumscribe the respective orifices in the stator, but their shape could vary and a generally annular recess or the annular shape with radially inwardly directed projections, is not essential. The recess could additionally or alternatively be formed in the rotors described above. Also, while the stator has been described as having plural ports, and the rotor as having fewer ports, it is possible that the rotor may have plural inlet ports and the stator may have fewer ports. In that case, flexible hoses will be connected to the rotor inlet ports.

Embodiments of the rotary selection valve described above provide for better cleaning or sanitisation of the valve, because bacteria or other microorganisms cannot pass radially beyond the fluid recesses described above. The valve can be cleaned by automated means and need not be dismantled so frequently.

What is claimed is:

1. A rotary selection valve (1), the valve comprising a stator (20) and a rotor (40), said stator (20) and rotor (40) each having complementary abutment surfaces (30,50) for allowing generally fluid tight relative rotation between the stator (20) and the rotor (40) about a rotational axis, said stator or rotor comprising at least one connection port in fluid communication with an associated orifice at said stator or rotor abutment surface (30), characterised in that said stator and/or said rotor further comprises a fluid recess extending radially beyond said associated orifice or orifices and open to the complementary abutment surfaces.

2. A rotary selection valve as claimed in claim 1, wherein said at least one connection port is a plurality of connection ports and the valve includes a plurality of associated orifices at the complementary abutment surfaces, and wherein the fluid recess substantially circumscribes the orifices.

3. A rotary selection valve as claimed in claim 2, wherein the orifices are arranged in a circular array and said recess is formed at least radially outwardly of each orifice in the array.

4. A rotary selection valve as claimed in claim 3, wherein, the recess extends also between the orifices in the array.

5. A rotary selection valve as claimed in any one of claim 1, wherein the recess has an inlet and in outlet, each in fluid communication with a respective connection port at the stator or rotor.

6. A rotary selection valve as claimed in claim 5, wherein the inlet is located generally at the rotational axis, and the fluid recess further extends to the inlet at the rotational axis.

7. A rotary selection valve (1), the valve comprising a stator (20) and a rotor (40), said stator (20) and rotor (40) each having complementary abutment surfaces (30,50) for allowing generally fluid tight relative rotation between the stator (20) and the rotor (40) about a rotational axis, said stator comprising a plurality of connection ports each in fluid communication with an associated orifice in said stator abutment surface (30), characterised in that said stator further comprises a fluid recess (34) extending radially beyond said orifices and open to the stator abutment surface (30), in that the fluid recess (34) extends also in between the orifices, in that an inlet for the fluid channel is formed by a further central orifice (21) at the rotational axis and in that a fluid path (32) is formed in the rotor extending from the inlet radially outwardly to meet the fluid recess.

8. A method of cleansing a rotary selection valve, the method comprising the step of
causing fluid to flow in a fluid recess of a rotary selection valve (1), the valve comprising a stator (20) and a rotor (40), said stator (20) and rotor (40) each having complementary abutment surfaces (30,50) for allowing generally fluid tight relative rotation between the stator (20) and the rotor (40) about a rotational axis, said stator or rotor comprising at least one connection port in fluid communication with an associated orifice at said stator or rotor abutment surface (30), and the fluid recess comprising a fluid recess extending radially beyond said associated orifice or orifices and open to the complementary abutment surfaces.

9. A method of cleansing a rotary selection valve as claimed in claim 8, wherein said flow is constant or periodic.

10. A method of cleansing a rotary selection valve as claimed in claim 8, wherein said flow is caused by a pump associated with flow of further fluids in each connection port and associated orifice.
